(19) United States
(12) Patent Application Publication
(10) Pub. No.: US 2023/0382034 A1
(43) Pub. Date: Nov. 30, 2023

(54) INJECTION MOLDING MACHINE AND OPERATOR SUPPORT METHOD

(71) Applicant: THE JAPAN STEEL WORKS, LTD., Tokyo (JP)

(72) Inventors: Takuya YUFU, Tokyo (JP); Akihiro Naito, Tokyo (JP); Yasutaka Otsuji, Tokyo (JP)

(73) Assignee: THE JAPAN STEEL WORKS, LTD., Tokyo (JP)

(21) Appl. No.: 18/322,358

(22) Filed: May 23, 2023

(30) Foreign Application Priority Data
May 25, 2022 (JP) 2022-084940

(51) Int. Cl. B29C 45/76; B29C 45/78; B29C 45/47

(52) U.S. Cl. CPC B29C 45/7666; B29C 45/78; B29C 45/47; B29C 2945/76665; B29C 2945/76521; B29C 2945/76531; B29C 2945/76668; B29C 2045/7606

(57) ABSTRACT

An injection molding machine includes a control device configured to output at least one set of operator support information. The operator support information includes a set of support target setting data and control target predicted amount of power. The support target setting data includes at least one piece of setting data configuring a molding condition. The control target predicted amount of power is a predicted amount of power consumption of a control target controlled in association with the support target setting data with respect to a change in the support target setting data.

### CROSS-REFERENCE TO RELATED APPLICATIONS

This application is based on and claims priority under 35 USC 119 from Japanese Patent Application No. 2022-084940 filed on May 25, 2022, the entire content of which is incorporated herein by reference.

### TECHNICAL FIELD

The present disclosure relates to an injection molding machine having a servo motor, and an operator support method for providing an operator with information that leads to a reduction in an amount of power consumption regarding the injection molding machine.

### BACKGROUND

An injection molding machine includes a mold clamping device for clamping a mold, an injection apparatus configured to melt an injection material and to inject the molten injection material into the mold, and the like. An injection molding machine configured to drive these devices by respective servo motors is called an electric injection molding machine. Such an injection molding machine is configured to: convert three-phase AC power supplied from a factory into DC power by a converter; convert the DC power into a three-phase AC current of a desired current at a desired frequency by an inverter; and supply the three-phase AC current to the servo motor. As a result, the devices are driven.

Japanese Patent No. 5654250 describes an injection molding machine in which two different control modes are prepared for a control method of a servo motor, and an operator can select a desired control mode for at least two steps configuring a molding cycle. Between the two different control modes, one is a control mode in which power consumption is reduced with respect to the other one, and energy saving operation is enabled by selecting a control mode in which power consumption is small.

### SUMMARY

In recent years, there has been a demand in the industrial world to comply with the sustainable development goals, and a reduction in the amount of power consumed by injection molding machines has also been demanded. In the injection molding machine disclosed in Japanese Patent No. 5654250, by selecting a control mode in which power consumption is small, the energy saving operation is enabled, which is excellent for reducing the amount of power. However, there is also a problem to be solved. The injection molding machine disclosed in the Literature can only select from two different control modes for servo motor control, and regardless of which control mode is selected, the machine operates according to molding conditions set by the operator. Depending on the molding conditions, it may be possible to reduce the amount of power by reviewing setting data, but such review of the molding conditions is not taken into consideration.

The present disclosure provides an injection molding machine that outputs operator support information related to a reduction in an amount of power consumption.

Other problems and novel features will become apparent from description of the present description and the accompanying drawings.

The present disclosure relates to an injection molding machine including a control device. The control device is configured to output at least one set of operator support information. The operator support information includes a set of support target setting data and control target predicted amount of power. The support target setting data includes at least one piece of setting data configuring a molding condition. The control target predicted amount of power is a predicted amount of power consumption of a control target controlled in association with the support target setting data with respect to a change in the support target setting data.

According to the present disclosure, it is possible to provide an operator with information for reviewing a molding condition that leads to a reduction in an amount of power consumption.

### BRIEF DESCRIPTION OF DRAWINGS

FIG. 1 is a front view showing an injection molding machine according to the present illustrative embodiment.

FIG. 2 is a power supply system diagram for a servo motor in the injection molding machine according to the present illustrative embodiment.

FIG. 3A is a time chart showing each step in a molding cycle.

FIG. 3B is a graph showing changes in a transport flow rate of an injection material with respect to a screw rotation speed.

FIG. 3C is a graph showing changes in a metering time with respect to the screw rotation speed.

FIG. 3D is a graph showing changes in power consumption of a plasticization servo motor with respect to the screw rotation speed.

FIG. 3E is a graph showing changes in an amount of power consumption by the plasticization servo motor with respect to the screw rotation speed.

FIG. 4 is a graph showing changes in a screw position, changes in a molded product weight, changes in power consumption of an injection servo motor, and changes in an amount of power consumption of the injection servo motor with respect to an elapsed time in an injection step and a pressure holding step.

FIG. 5 is a graph showing changes in the amount of power consumption of the injection servo motor with respect to back pressure applied to a screw.

FIG. 6 is a power reduction support screen according to the present illustrative embodiment.

### DETAILED DESCRIPTION

Hereinafter, a specific illustrative embodiment will be described in detail with reference to the drawings. The present disclosure is not limited to the following illustrative embodiment. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

An operator support method according to the present illustrative embodiment, which will be described in detail later, is a method for providing an operator with information that leads to a reduction in an amount of power consumption in a servo motor, a heater and the like in an injection molding machine that includes the servo motor, the heater and the like. The injection molding machine may be a vertical injection molding machine, but in the following description, a horizontal injection molding machine will be described as an example.

### {Injection Molding Machine}

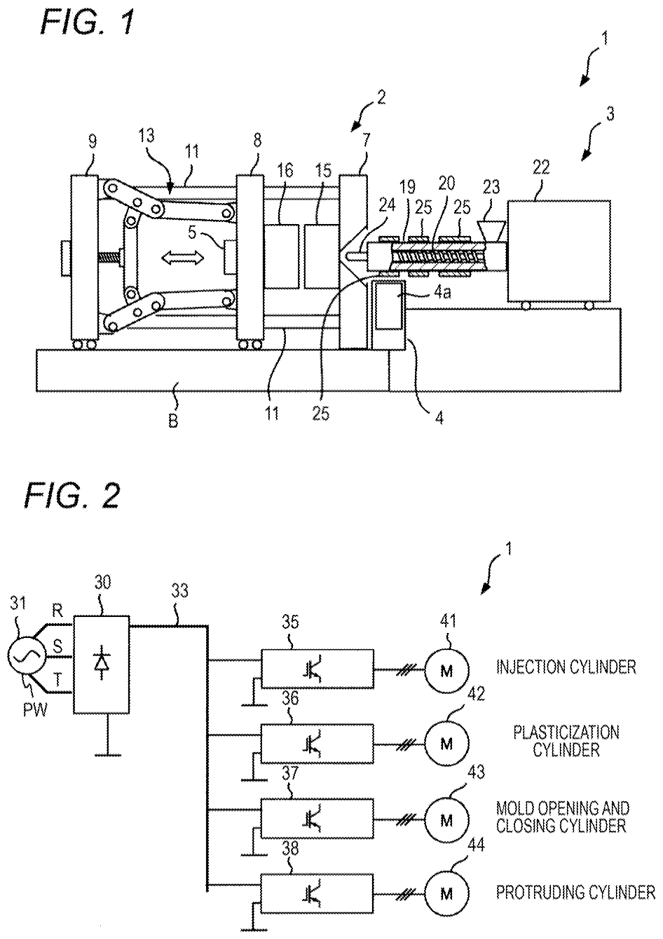

As shown in FIG. 1, an injection molding machine 1 according to the present illustrative embodiment includes a mold clamping device 2, an injection apparatus 3, a protruding device 5 and the like. The injection molding machine 1 includes a controller, that is, a control device 4. The mold clamping device 2, the injection apparatus 3, the protruding device 5, and the like are controlled by the control device 4. A monitor 4a is provided in the control device 4, and various screens are displayed.

### {Mold Clamping Device}

The mold clamping device 2 includes a fixed plate 7 fixed to a bed B, a movable plate 8 slidably provided on the bed B, and a mold clamping housing 9. The fixed plate 7 and the mold clamping housing 9 are connected by a plurality of tie bars 11, 11, . . . . The movable plate 8 is slidable between the fixed plate 7 and the mold clamping housing 9. A mold clamping mechanism is provided between the mold clamping housing 9 and the movable plate 8. That is, in the present illustrative embodiment, a toggle mechanism 13 is provided between the mold clamping housing 9 and the movable plate 8. A mold 15 on a fixed side and a mold 16 on a movable side are provided on the fixed plate 7 and the movable plate 8, respectively. Therefore, the molds 15 and 16 are opened and closed when the toggle mechanism 13 is driven. The protruding device 5 for protruding a molded product is provided on the movable plate 8.

### {Injection Apparatus}

The injection apparatus 3 includes a heating cylinder 19, a screw 20 provided in the heating cylinder 19, and a screw driving device 22. The heating cylinder 19 is supported by the screw driving device 22. The screw 20 is driven by the screw driving device 22 in a rotational direction and an axial direction. The heating cylinder 19 is provided with a hopper 23 and an injection nozzle 24. Further, heaters 25, 25, . . . are provided in the heating cylinder 19.

The injection apparatus 3 is moved forward to bring the injection nozzle 24 into contact with the mold 15 on the fixed side. In response to an instruction from the control device 4, power is supplied to the heaters 25, 25, . . . to heat the heating cylinder 19. Then, the injection material is supplied from the hopper 23, and the screw 20 is rotated. Then, the injection material is melted and sent to a tip end of the screw 20. That is, the injection material is metered. After the injection material is metered, in response to an instruction from the control device 4, the screw driving device 22 is controlled to drive the screw 20 in the axial direction. Then, the injection material is pushed forward along with forward movement of the screw 20. That is, the injection material is injected into the molds 15 and 16.

### {Power Supply System}

The injection molding machine 1 according to the present illustrative embodiment is driven by a servo motor. A power supply system will be described. As shown in FIG. 2, the injection molding machine 1 according to the present illustrative embodiment is provided with a converter 30. The converter 30 is connected to a three-phase AC power supply 31 in a factory, and is also connected to a DC voltage line 33 provided in the injection molding machine 1. A plurality of inverters, that is, servo amplifiers 35, 36, 37, 38, . . . are connected to the DC voltage line 33. The servo amplifiers 35, 36, 37, 38, . . . are provided with servo motors 41, 42, 43, 44, . . . , respectively. That is, an injection servo motor 41, a plasticization servo motor 42, a mold opening and closing servo motor 43, a protruding servo motor 44, . . . are provided.

Three-phase AC power from the three-phase AC power supply 31 is converted into DC power by the converter 30 and supplied to the DC voltage line 33. Then, the DC power is converted into three-phase AC power of a desired current at a desired frequency by the servo amplifiers 35, 36, 37, 38, . . . , and is supplied to the servo motors 41, 42, 43, 44, . . . , respectively. As a result, the servo motors 41, 42, 43, 44, . . . are driven. The operator support method according to the present illustrative embodiment described below is a method for providing information that leads to a reduction in an amount of power consumed by the servo motors 41, 42, 43, 44, . . . , that is, an amount of power consumed by the servo amplifiers 35, 36, 37, 38, . . . .

### {Operator Support Method}

The operator support method according to the present illustrative embodiment is a method for providing an operator with information related to a change in setting data of a molding condition and leading to a reduction in an amount of power consumption. The operator support method is implemented by the control device 4 and is designed to provide operator support information, which will be specifically described below.

### {Operator Support Information}

The operator support information includes a set of support target setting data and control target predicted amount of power. The support target setting data includes one piece or a plurality pieces of setting data configuring a molding condition. For example, a screw rotation speed set in a metering step may be set as the support target setting data. The control target predicted amount of power is an amount of power consumption predicted when the support target setting data is changed for a control target controlled in relation to the support target setting data. For example, one of the servo motors 41, 42, 43, 44, . . . corresponds to the control target. Alternatively, the heaters 25, 25, . . . may correspond to the control target. When the support target setting data is the screw rotation speed, the control target predicted amount of power is predicted amount of power of the plasticization servo motor 42.

The control device 4 is configured to calculate how the control target predicted amount of power changes assuming that the support target setting data is changed, and to provide the result to an operator as operator support information. With reference to the result, the operator can change the support target setting data and reduce the amount of power consumption. The injection molding machine 1 according to the present illustrative embodiment provides a plurality of sets of operator support information. The plurality of sets of operator support information provided by the injection molding machine 1 according to the present illustrative embodiment will be described one by one.

### {Operator Support Information (1)}

In operator support information described first as a first set, the support target setting data is the screw rotation speed in a metering step, and the control target predicted amount of power is a predicted amount of power of the plasticization servo motor 42 in the metering step. The control device 4 provides information indicating how the amount of power of the plasticization servo motor 42 changes when the screw rotation speed is changed. How the control device 4 provides the operator support information will be described.

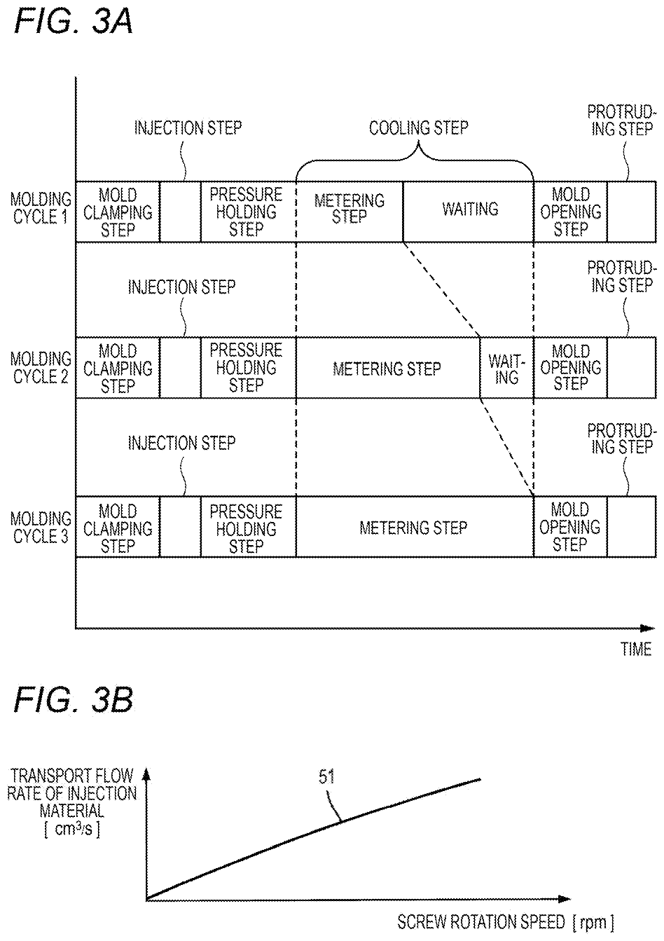

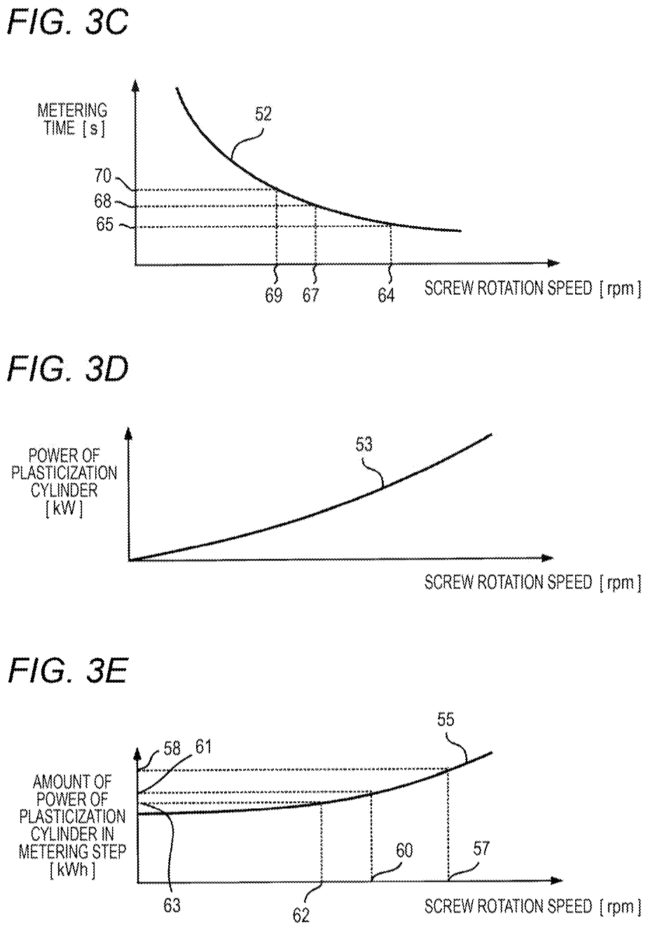

In FIG. 3A, molding cycle 1 is a time chart when a molding cycle is performed according to molding conditions currently set in the control device 4. That is, a mold clamping step of clamping the molds 15 and 16 (see FIG. 1) is performed, and an injection step and a pressure holding step of filling the molds 15 and 16 with the injection material are performed. Subsequently, a cooling step of waiting for the injection material to solidify is performed, and a molded product is obtained by a mold opening step of opening the molds 15 and 16 and a protruding step of protruding the molded product. During the cooling step, a metering step is performed to meter the injection material in preparation for the next molding cycle. That is, the screw 20 (see FIG. 1) is rotated to feed the injection material to the front of the screw 20, and a predetermined amount of injection material is metered. When the metering step is completed, the process waits until the cooling step is completed.

In the metering step, the screw 20 is rotated to transport the injection material to the front of the heating cylinder 19 (see FIG. 1), and a relationship between the screw rotation speed and a transport flow rate of the injection material is shown in a graph 51 of FIG. 3B. That is, as the screw rotation speed increases, the transport flow rate of the injection material increases. The relationship between the screw rotation speed and the transport flow rate of the injection material is stored in the control device 4 in advance. A time required for the metering step, that is, a metering time, can be calculated based on an amount of the injection material to be metered and the transport flow rate of the injection material. The amount of the injection material to be metered here is determined by the molded product to be molded, and the relationship between the transport flow rate of the injection material and the screw rotation speed is stored in the control device 4. Therefore, the control device 4 can calculate the metering time based on the screw rotation speed. A relationship between the screw rotation speed and the metering time calculated by the control device 4 is shown in a graph 52 of FIG. 3C.

Incidentally, power for driving the plasticization servo motor 42 changes according to the screw rotation speed as shown in a graph 53 of FIG. 3D. This relationship is also stored in the control device 4. An amount of power of the plasticization servo motor 42 in the metering step is obtained by integrating such power over the metering time. The metering time changes according to the screw rotation speed as shown in the graph 52 of FIG. 3C, and this relationship is calculated by the control device 4 as described above. In this way, the control device 4 can calculate a relationship between the screw rotation speed and the amount of power of the plasticization servo motor 42 in the metering step. This relationship is shown in a graph 55 of FIG. 3E. As can be seen from the graph 52 of FIG. 3C and the graph 55 of FIG. 3E, as the screw rotation speed is decreased, the metering time is increased, and the amount of power of the plasticization servo motor 42 is reduced.

In FIG. 3E, a currently set screw rotation speed is indicated as a current set value 57, and the amount of power of the plasticization servo motor 42 (see FIG. 2) at that time is indicated as a current amount of power 58. Here, for example, assuming that the screw rotation speed is changed to a first modified example 60, it is predicted that the amount of power of the plasticization servo motor 42 (see FIG. 2) decreases to a predicted amount of power 61. Incidentally, in FIG. 3C, the metering time is the time indicated by reference numeral 65 with respect to a current set value 64 of the screw rotation speed. This is shown as a metering step in molding cycle 1 of FIG. 3A. Here, when the screw rotation speed is changed to a first modified example 67 (corresponding to the first modified example 60 in FIG. 3E), the metering time is increased as indicated by reference numeral 68. In FIG. 3A, a time chart of each step when the screw rotation speed is changed to the first modified examples 60 and 67 is shown as molding cycle 2. In molding cycle 2, the metering step is longer and the waiting is shortened in comparison with those in molding cycle 1.

In FIG. 3E, it is assumed that the screw rotation speed is further decreased to a second modified example 62. Then, it is predicted that the amount of power of the plasticization servo motor 42 (see FIG. 2) decreases to a predicted amount of power 63. That is, it can be seen that the amount of power can be significantly reduced. At this time, as shown in FIG. 3C, when the screw rotation speed is changed to a second modified example 69 (corresponding to the second modified example 62 in FIG. 3E), the metering time is increased as indicated by reference numeral 70. In FIG. 3A, a time chart of each step when the screw rotation speed is changed to the second modified examples 62 and 69 is shown as molding cycle 3. In molding cycle 3, although the metering step is increased, the waiting is eliminated. A length of the cooling step is equal between molding cycle 1 and molding cycle 3.

Here, assuming that the screw rotation speed is further decreased, as can be seen from the graph 52 of FIG. 3C, the metering time further increases. Therefore, the cooling step becomes longer, and as a result, the molding cycle becomes longer. If the molding cycle is long, productivity is lowered, which is not preferable. As shown in FIG. 3E, the control device 4 (see FIG. 1) recommends, for example, the second modified example 62 as the screw rotation speed, and provides the operator with the predicted amount of power 63 of the plasticization servo motor 42 (see FIG. 2) expected at that time. Incidentally, the operator support information including the recommended set value and the predicted amount of power is displayed on a power reduction support screen which will be explained later.

### {Operator Support Information (2)}

In operator support information described as a second set, the support target setting data is a pressure holding time in the pressure holding step, and the control target predicted amount of power is a predicted amount of power of the injection servo motor 41 (see FIG. 2) in the pressure holding step. The control device 4 (see FIG. 1) provides information indicating how the amount of power of the injection servo motor 41 changes when the pressure holding time is changed.

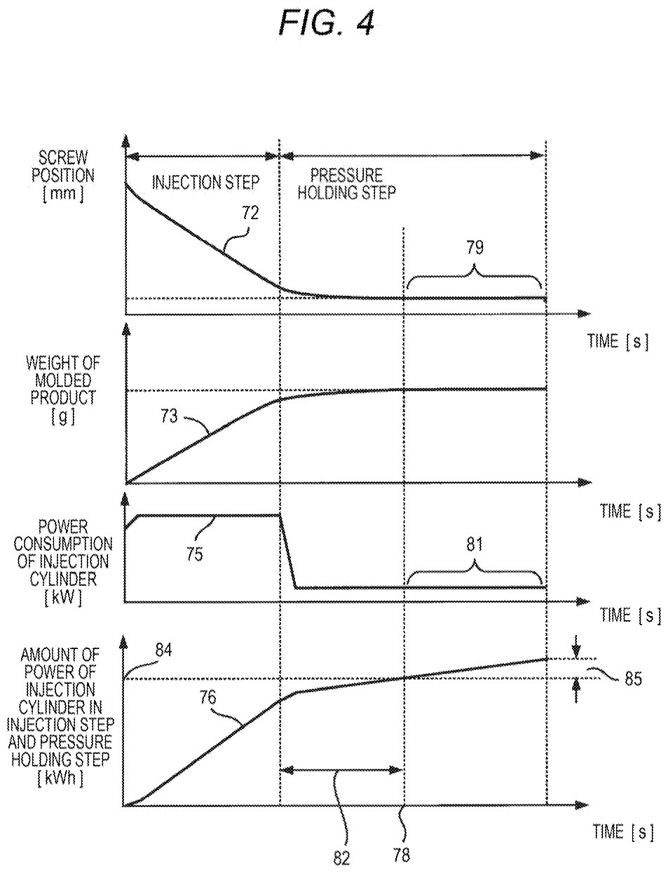

A graph 72 of FIG. 4 is a graph showing a screw position that changes with time in the injection step in which the injection material is injected into the molds 15 and 16 (see FIG. 1) and in the pressure holding step in which pressure is applied to the injection material. When the screw position changes and the molds 15 and 16 are filled with the injection material, a weight of the molded product increases. A graph 73 shows how the weight of the molded product increases. As can be seen from the graph 73, the weight of the molded product increases greatly in the injection step, then a rate of the increase decreases in the pressure holding step, and the weight of the molded product eventually reaches a constant value. Power consumption consumed in the injection servo motor 41 (see FIG. 2) in the injection step and the pressure holding step is shown in a graph 75, and an integrated value thereof, that is, the amount of power of the injection servo motor 41 in the pressure holding step is shown in a graph 76.

The control device 4 (see FIG. 1) monitors a change in the screw position in the pressure holding step for each molding cycle. It is detected that the screw position hardly changes in a time period 79 after a timing 78. The time period 79 indicates that the weight of the molded product does not change and substantially no injection material enters the molds 15 and 16 from a gate. Therefore, it can be seen that, thereafter, the power during a time period indicated by a reference numeral 81 for applying the pressure to the injection material is wasted. The control device 4 recommends a time indicated by a reference numeral 82 as the pressure holding time. That is, it is recommended that no pressure holding is performed after the timing 78. A predicted amount of power 84 of the injection servo motor 41 (see FIG. 2) at this time is also provided to the operator. In this case, a predicted reduction amount 85 for the power of the injection servo motor 41 may be provided.

### {Operator Support Information (3)}

In operator support information described as a third set, the support target setting data is back pressure in the metering step, and the control target predicted amount of power is a predicted amount of power of the injection servo motor 41 (see FIG. 2) in the metering step. The control device 4 provides information indicating how the amount of power of the injection servo motor 41 changes when the back pressure is changed.

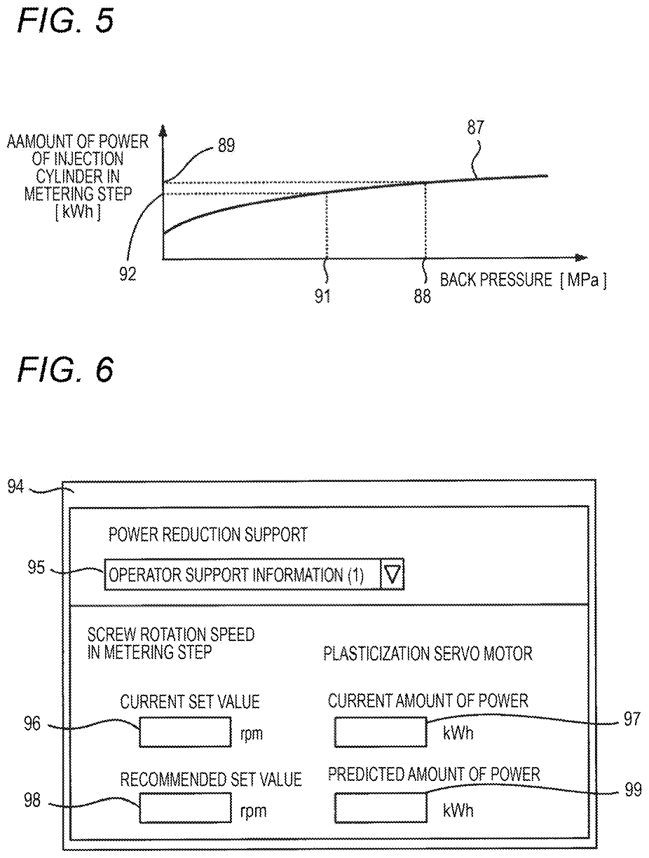

FIG. 5 shows a graph 87 indicating an amount of power consumed by the injection servo motor 41 (see FIG. 2) in the metering step when the back pressure is changed. The control device 4 (see FIG. 1) provides information related to a case where a current set value 88 of the back pressure is set to, for example, a change value 91. In this case, it is expected that an amount of power of the injection servo motor 41 is reduced from a current amount of power 89 to a predicted amount of power 92. The predicted amount of power 92 is also provided to the operator. The operator support information also includes the support target setting data that can propose a recommended set value, such as the operator support information that has been described as the first set and the second set. However, it may be difficult to propose a recommended set value as the support target setting data. It can be said that the back pressure is such support target setting data. Therefore, the control device 4 does not propose a recommended set value for the back pressure, and provides reference information such as a change in the predicted amount of power 92 if the back pressure is set to the change value 91, for example.

Incidentally, the support target setting data may be set as the back pressure in the metering step, and the control target may be set as the plasticization servo motor 43 (see FIG. 2). That is, the control target predicted amount of power for the plasticization servo motor 43 is handled. In this case, as the back pressure is decreased, the amount of power required for driving the plasticization servo motor 43 is decreased. Further, the support target setting data may be set as the back pressure in the metering step, and the control target may be set as the injection servo motor 41 (see FIG. 2) and the plasticization servo motor 43. That is, the control target predicted amount of power is a prediction of the amount of power consumption by the injection servo motor 41 and the plasticization servo motor 43.

### {Other Operator Support Information}

For the operator support information of the first set, the second set, and the third set described above, the control target in the control target predicted amount of power are all the servo motors 41, 42, . . . . There is also operator support information in which the control target in the control target predicted amount of power is the heaters 25, 25, . . . . In such operator support information, for example, the support setting target data is configured by a resin type and a target temperature of the heating cylinder 19 (see FIG. 1). In this case, the control target predicted amount of power becomes an amount of power consumption predicted for the heaters 25, 25, . . . . When the resin type is changed or the target temperature is decreased by a predetermined magnitude, the amount of power consumption predicted for the heaters 25, 25, . . . changes. Therefore, it is possible to recommend the change of the resin type or the change of the target temperature as the support target setting data, and to provide the control target predicted amount of power at that time.

### {Power Reduction Support Screen}

A power reduction support screen 94 according to the present illustrative embodiment shown in FIG. 6 is displayed on the monitor 4a of the control device 4 (see FIG. 1). The power reduction support screen 94 displays the operator support information to provide the operator with information on a change in the molding conditions that leads to a reduction in the amount of power. A pull-down menu 95 is provided in an upper part of the screen, and operator support information desired to be displayed is selected in the pull-down menu 95. FIG. 6 shows a state in which “operator support information (1)” is selected. In this case, the operator support information of the first set is displayed in a lower part of the screen.

As described above, in the operator support information of the first set, the support target setting data is the screw rotation speed in the metering step, and the control target predicted amount of power is a predicted amount of power of the plasticization servo motor 42 (see FIG. 2) in the metering step. The power reduction support screen 94 includes a display field 96 for the current set value of the screw rotation speed, which is the support target setting data, and a display field 97 for the amount of power of the plasticization servo motor 42 in the metering step. Further, the power reduction support screen 94 includes a display field 98 for a set value recommended as the screw rotation speed and a display field 99 for the predicted amount of power of the plasticization servo motor 42 predicted at that time. The operator reviews the molding conditions with reference to the operator support information displayed in these display fields 96, 97, 98, and 99.

### Modifications of Present Illustrative Embodiment

The present illustrative embodiment may be variously modified. For example, it has been described that the operator support information provided to the operator includes the support target setting data and the control target predicted amount of power. However, a predicted average power may be used instead of the predicted amount of power for the control target. This is because the average power obtained by time-averaging the power as an instantaneous value is substantially equivalent to the amount of power. In addition, the control target predicted amount of power provided to the operator may be a decrease in the amount of power of the control target whose change is predicted, that is, a decrease in the control target predicted amount of power, due to the change in the support target setting data. This is because when the decrease in the amount of power is predicted and provided to the operator, it is substantially equivalent to providing the control target predicted amount of power.

Other modifications can be made. For example, the support target setting data may include two pieces of setting data, the screw rotation speed and the back pressure in the metering step. In this case, since there are two servo motors associated with the support target setting data, the injection servo motor 41 and the plasticization servo motor 42, a servo motor predicted amount of power is obtained by summing amounts of power of the two servo motors 41 and 42.

Although the invention made by the present inventors is specifically described based on the illustrative embodiment, it is needless to say that the present invention is not limited to the illustrative embodiment described above, and various modifications can be made without departing from the scope of the invention. A plurality of examples described above may be implemented in combination as appropriate.

What is claimed is:

1. An injection molding machine comprising:
a control device configured to output at least one set of operator support information,
wherein the operator support information includes a set of support target setting data and control target predicted amount of power,
wherein the support target setting data includes at least one piece of setting data configuring a molding condition, and
wherein the control target predicted amount of power is a predicted amount of power consumption of a control target controlled in association with the support target setting data with respect to a change in the support target setting data.

2. The injection molding machine according to claim 1, further comprising:
a plurality of servo motors,
wherein in the at least one set of the operator support information, the control target is one of the plurality of servo motors controlled in association with the support target setting data, and the control target predicted amount of power is power consumption predicted for the one of the plurality of servo motors.

3. The injection molding machine according to claim 1, further comprising:
a heater,
wherein in the at least one set of the operator support information, the control target is the heater, and the control target predicted amount of power is power consumption predicted for the heater.

4. The injection molding machine according to claim 2, further comprising:
a heating cylinder; and
a screw disposed in the heating cylinder,
wherein the plurality of servo motors includes a plasticization servo motor configured to rotate the screw, and
wherein in the one set of the operator support information, the support target setting data is a screw rotation speed in a metering step, and the control target is the plasticization servo motor.

5. The injection molding machine according to claim 2, further comprising:
a heating cylinder; and
a screw disposed in the heating cylinder,
wherein the plurality of servo motors includes an injection servo motor configured to drive the screw in an axial direction, and
wherein in the one set of the operator support information, the support target setting data is a pressure holding time in a pressure holding step, and the control target is the injection servo motor.

6. The injection molding machine according to claim 2, further comprising:
a heating cylinder; and
a screw disposed in the heating cylinder,
wherein the plurality of servo motors includes an injection servo motor configured to drive the screw in an axial direction and a plasticizing screw configured to rotate the screw, and
wherein in the one set of the operator support information, the support target setting data is back pressure in a plasticizing step, and the control target is at least one of the injection servo motor or the plasticizing screw.

7. The injection molding machine according to claim 4, wherein the control device is configured to:
calculate and display recommended setting data for the screw rotation speed; and
display the control target predicted amount of power corresponding to the recommended setting data.

8. The injection molding machine according to claim 5, wherein the control device is configured to:
calculate and display recommended setting data for the pressure holding time; and
display the control target predicted amount of power corresponding to the recommended setting data.

9. An operator support method for an injection molding machine, the injection molding machine comprising a control device, the operator support method comprising:
causing the control device to output at least one set of operator support information, the operator support information including a set of support target setting data and control target predicted amount of power,
wherein the support target setting data includes at least one piece of setting data configuring a molding condition, and
wherein the control target predicted amount of power is a predicted amount of power consumption of a control target controlled in association with the support target setting data with respect to a change in the support target setting data.

10. The operator support method according to claim 9,
wherein the injection molding machine comprises a plurality of servo motors, and
wherein the operator support method comprises causing the control device to output the at least one set of the operator support information, in which the control target is one of the plurality of servo motors controlled in association with the support target setting data, and the control target predicted amount of power is power consumption predicted for the one of the plurality of servo motors.

11. The operator support method according to claim 9,
wherein the injection molding machine comprises a heater, and
wherein the operator support method comprises causing the control device to output the at least one set of the operator support information, in which the control target is the heater, and the control target predicted amount of power is power consumption predicted for the heater.

12. The operator support method according to claim 10,
wherein the injection molding machine comprises a heating cylinder and a screw disposed in the heating cylinder,
wherein the plurality of servo motors includes a plasticizing servo motor configured to rotate the screw, and
wherein the operator support method comprises causing the control device to output the one set of the operator support information, in which the support target setting data is a screw rotation speed in a metering step, and the control target is the plasticization servo motor.

13. The operator support method according to claim 10,
wherein the injection molding machine comprises a heating cylinder and a screw disposed in the heating cylinder,
wherein the plurality of servo motors includes an injection servo motor configured to drive the screw in an axial direction, and
wherein the operator support method comprises causing the control device to output the one set of the operator support information, in which the support target setting data is a pressure holding time in a pressure holding step, and the control target is the injection servo motor.

14. The operator support method according to claim 10,
wherein the injection molding machine comprises a heating cylinder and a screw disposed in the heating cylinder,
wherein the plurality of servo motors includes an injection servo motor configured to drive the screw in an axial direction, and
wherein the operator support method comprises causing the control device to output the one set of the operator support information, in which the support target setting data is back pressure in a plasticizing step, and the control target is the injection servo motor.

15. The operator support method according to claim 12, wherein in the causing of the control device to output the one set of the operator support information, the operator support method comprises causing the control device to:
calculate and display recommended setting data for the screw rotation speed; and
display the control target predicted amount of power corresponding to the recommended setting data.

16. The operator support method according to claim 13, wherein in the causing of the control device to output the one set of the operator support information, the operator support method comprises causing the control device to:
calculate and display recommended setting data for the pressure holding time; and
display the control target predicted amount of power corresponding to the recommended setting data.
